(19) United States
(12) Patent Application Publication
(10) Pub. No.: US 2003/0014321 A1
(43) Pub. Date: Jan. 16, 2003

(54) System for single-action scan and purchase in a physical environment

(75) Inventors: Edith Helen Stern, Yorktown Heights, NY (US); David Perry Greene, Ossining, NY (US); Barry Edward Willner, Briarcliff Manor, NY (US); Philip Shi-lung Yu, Chappaqua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/905,413

(22) Filed: Jul. 13, 2001

(51) Int. Cl. G06F 17/60

(52) U.S. Cl. 705/26; 705/27

(57) ABSTRACT

A method, computer program product, and data processing system for conducting purchases of products with only a single action to be performed by the purchaser is disclosed. A user captures an image of an item for purchase with a client device, to which the user performs only a single action (e.g., pressing a button). The client device transmits the image and a client identifier to a central server, which identifies the item and combines the information about the item with customer billing and shipping information to automatically create and process an order for the item without any further intervention by the user.

### BACKGROUND OF THE INVENTION

1. Technical Field

The present invention is directed toward portable shopping terminal devices. More particularly, the present invention is directed toward a portable shopping terminal device system that allows for purchases to be made with a single action by the user.

2. Description of Related Art

A number of portable handheld shopping terminal devices have been developed to aid consumers in making purchases. Such terminals generally include some sort of barcode reader for scanning in an identifying bar code for each product to be purchased. Items that have been scanned may be displayed on the terminal, and a verification step may be required. At the end of the shopping session, in a “check out” mode, the identities of the products are uploaded to another device for processing the user's order. A number of ways of uploading the product order have been developed. The terminal device can be connected to a home docking station and the order transmitted via modem. Alternatively, the terminal device can be connected to a kiosk within a store and the customer's order uploaded through the kiosk.

Existing terminal devices, however, are still somewhat inconvenient in that the user must perform an affirmative checkout act, by docking the shopping terminal with some other device, either at home or in a store, or by some other affirmative act concluding a shopping session. Forcing a user to dock his or her terminal and initiate some kind of checkout process at the conclusion of every shopping session is an annoyance. Accordingly, a shopping terminal system without the burdensome necessity of a separate checkout procedure is desired. Further, users frequently carry a number of devices such as cellular phones, pagers, PDAs, and so forth. Users may not choose to carry a specialized shopping terminal as well. Accordingly, it is desirable to have the same capability in a more generic device that is useful for other purposes.

### SUMMARY OF THE INVENTION

The present invention provides a method, computer program product, and data processing system for conducting purchases of products with only a single action to be performed by the purchaser. A user captures an image of an item for purchase with a client device, to which the user performs only a single action (e.g., pressing a button). The client device transmits the image and a client identifier to a central server, which identifies the item and combines the item information with customer billing and shipping information to automatically create and process an order without any further intervention by the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed data processing system in which the processes of the present invention can be implemented;

FIG. 2 is a block diagram of a central server in accordance with a preferred embodiment of the present invention;

FIG. 3 is a block diagram of a client device in accordance with a preferred embodiment of the present invention;

FIG. 4 is a tabular diagram of an item information database in accordance with a preferred embodiment of the present invention;

FIG. 5 is a tabular diagram of an information provider database in accordance with a preferred embodiment of the present invention;

FIG. 6 is a tabular diagram of a user database in accordance with a preferred embodiment of the present invention;

FIG. 7A is a flowchart representation of a process of scanning a product for purchase in a preferred embodiment of the present invention; and

FIG. 7B is a flowchart representation of a process of generating a product order from a received image and customer identifier in a preferred embodiment of the present invention.

### DETAILED DESCRIPTION OF THE PREFERRED EMBODIMENT

FIG. 1 is a topographic view of a network architecture in accordance with a preferred embodiment of the present invention. Of course, network architectures other that that shown in FIG. 1 may be used to implement the invention.

FIG. 1 shows communication network 100 in communication with central server 102, client devices 104 to 108, and information providers 110 and 112. Communication network 100 may comprise any number of systems for transferring data, including a local area network, a wide area network, a telephone network, a cellular network, a fiber-optic network, a satellite network, an infrared network, a radio frequency network, the Internet, and any other type of network that may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

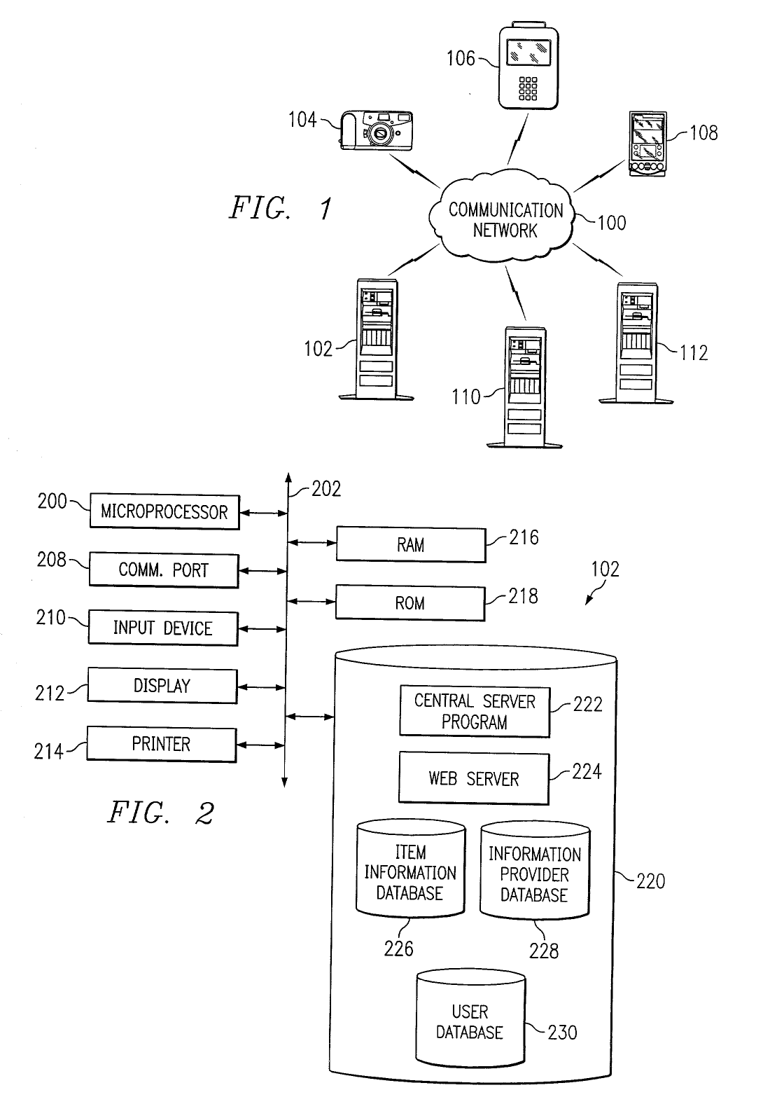

Central server 102 may comprise a network server or other device capable of performing the functions described herein. In addition to these functions, central server 102 may control various operations of an entity providing item information, including updating of decoding algorithms, billing, Web access, and the like. According to one embodiment, central server 102 operates to receive an image of an item identifier, and, based on the received image, to determine item information associated with an item identified by the item identifier. Details of one embodiment of central server 102 are set forth below with respect to FIG. 2.

Client devices 104 to 108 comprise a digital camera, a mobile telephone and a PDA (personal digital assistant), respectively. Each of client devices 104 to 108 includes peripherals for capturing an image, and may operate to capture an image of an item identifier, to transmit the image, and, in response to the transmission, to initiate a commercial transaction associated with an item identified by the item identifier. Although client devices 104 to 108 use similar systems for capturing images, image capture according to the invention may proceed using any system for capturing images in any format.

Information providers 110 and 112 comprise network servers and may be used to store item information and/or algorithms needed to decode images of item identifiers. Information providers 110 and 112 may also operate to decode item identifiers according to the stored algorithms. Moreover, each of information providers 110 and 112 may be operated by a different business entity and therefore may store only item information/decoding algorithms corresponding to items associated with the business entity.

In operation, one of client devices 104 to 108 captures an image of an item identifier and transmits the image to central server 102. Other central servers may exist, with the captured image being transmitted to a central server having a service contract with a user of the client device or with a retail store in which the image was captured. Central server 102 receives the image, determines the type of item identifier represented in the image, and decodes the item identifier according to the determined type. Decoding the identifier results in a code that is transmitted, along with customer information, to one of information providers 110 and 112 depending upon the format and/or content of the code. The information provider retrieves item information associated with the code and combines the item information with customer information (e.g., credit card information) associated with the identity of the client device to form an order for the customer. The order is then processed and fulfilled for the customer without further customer intervention.

An example of this invention may be understood from the following scenario. A user browses in a bookstore, and the user wishes to buy several books. The user captures an image of a barcode (usually present on the back of the book or on the jacket) through a device such as devices 104-108, and the device transmits the image to central server 102. Central server 102 identifies the image as a barcode specifying an ISBN (international standard book number). Central server 102 then transmits the ISBN to information provider 110 for action. Information provider 110 may belong to an electronic retailer (or “e-tailer”) that will create an order for the books, charge payment to the user, and ship the books the user's address. Alternatively, information provider 110 may belong to the retail establishment where the user is physically located, in which case the retail establishment assembles the order from stock on hand.

According to other embodiments, the elements of FIG. 1 are connected differently than as shown. For example, some or all of the elements may be connected directly to one another. Of course, embodiments of the invention may include elements that are different from those shown.

It should be noted that the devices shown in communication with each other might not be constantly exchanging data. Rather, communication may be established when necessary and severed at other times or always available but rarely used to transmit data. Moreover, although the illustrated communication links between the components of FIG. 1 appear dedicated, it should be noted that each of the links may be shared by other components.

FIG. 2 is a block diagram of the internal architecture of central server 102 according to one embodiment of the invention. As illustrated, central server 102 includes microprocessor 200 in communication with communication bus 202. Microprocessor 200 may be a Pentium™, RISC™-based, or other type of processor and is used to execute processor-executable process steps so as to control the components of central server 102 to provide functionality according to embodiments of the present invention.

Also in communication with communication bus 202 is communication port 208. Communication port 208 is used to transmit data to and to receive data from devices external to central server 102. Communication port 208 is therefore preferably configured with hardware suitable to physically interface with desired external devices and/or network connections. In one embodiment, images of item identifiers are received through communication port 208.

Input device 210, display 212 and printer 214 are also in communication with communication bus 202. Any known input device may be used as input device 210, including a keyboard, mouse, touch pad, voice-recognition system, or any combination of these devices. Input device 210 may be used by a business entity operating central server 102 to input item information and associated item identifiers, customer information (including addresses and credit card numbers), client device network addresses, information provider network addresses, and other information to central server 102. Of course, such information may also be input to central server 102 via communication port 208.

Display 212 may output text and graphics to an operator in response to commands issued by microprocessor 200, and may be an integral or separate CRT display, flat-panel display or the like. Printer 214 may also output text and graphics, but in hardcopy form using ink-jet, thermal, dot-matrix, laser, or other printing technologies. In one embodiment, printer 214 prints hardcopies of customer orders for shipment.

RAM 216 is connected to communication bus 202 to provide microprocessor 200 with fast data storage and retrieval. In this regard, processor-executable process steps being executed by microprocessor 200 are typically stored temporarily in RAM 216 and executed therefrom by microprocessor 200. ROM 218, in contrast, provides storage from which data can be retrieved but to which data cannot be stored. Accordingly, ROM 218 is used to store invariant process steps and other data, such as basic input/output instructions and data used during system boot-up or to control communication port 208. It should be noted that one or both of RAM 216 and ROM 218 may communicate directly with microprocessor 200 instead of over communication bus 202.

Data storage device 220 stores central server program 222, Web server 224, item information database 226, and information provider database 228. Central server program 222 consists of processor-executable process steps executed by microprocessor 200 in order to control central server 102 to determine item information in accordance with the present invention. More specifically, the process steps of central server program 222 may be executed by microprocessor 200 to capture an image of an item identifier and to transmit the image and customer information to an information provider for processing. As a result, updates in standards for decoding item identifiers might not require any change to client devices.

The process steps of central server program 222 may be read from a computer-readable medium, such as a floppy disk, a CD-ROM, a DVD-ROM, a Zip™ disk, a magnetic tape, or a signal encoding the process steps, and then stored in data storage device 220 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Web server 224 also comprises processor-executable process steps. The process steps may be executed by microprocessor 200 to transmit data to and to receive data from Web clients, such as Web browsers, over the Web.

Item information database 226 includes item information associated with item identifiers. Accordingly, item information database 226 may be used to determine item information based on a received image of an item identifier. A specific example of a portion of item information database 226 will be described with respect to FIG. 4.

Data used to communicate with information providers 110 and 112 is stored in information provider database 228. More particularly, the data specifies information providers that are capable of determining item information associated with particular types of item identifiers. The data is therefore used to determine to which information provider an item identifier should be sent. Further details of information provider database 228 are set forth with respect to FIG. 5.

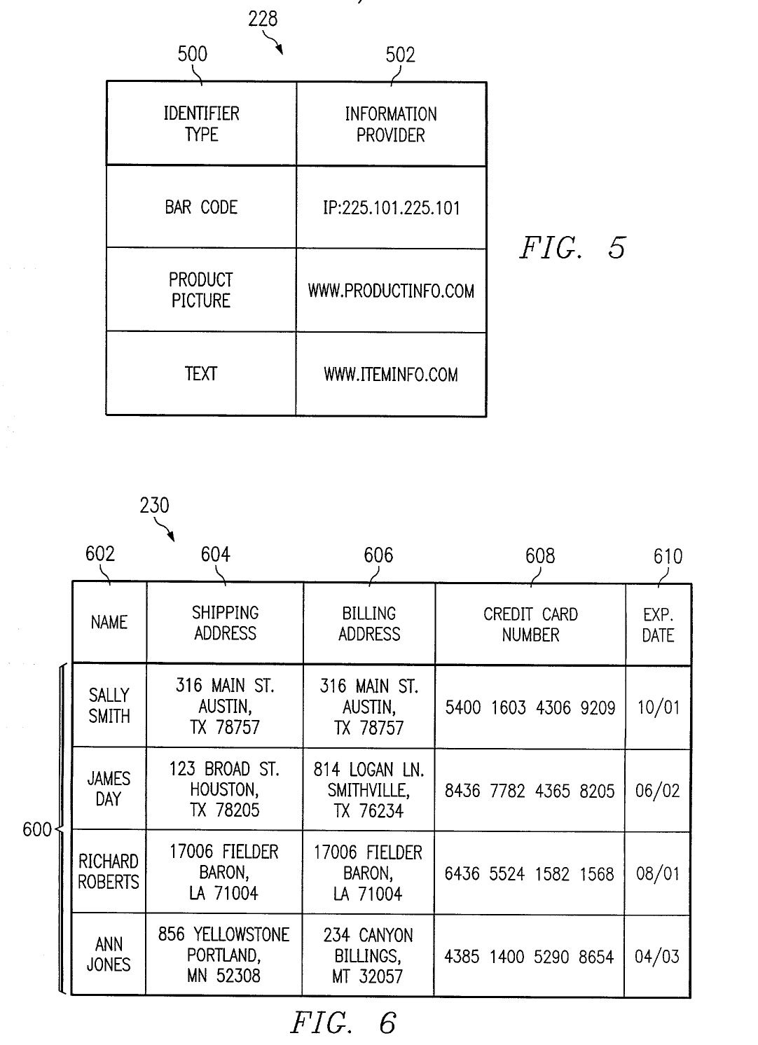

User database 230 stores information regarding customer-users of the purchase and scan service. In particular billing and shipping information for each customer is contained in user database 230. Further details of user database 230 are shown in FIG. 6.

Data storage device 220 may also store other unshown elements that may be necessary for operation of central server 102, such as other applications, other data files, an operating system, a database management system and “device drivers” for allowing microprocessor 200 to interface with devices in communication with communication port 208. These elements are known to those skilled in the art, and are therefore not described in detail herein.

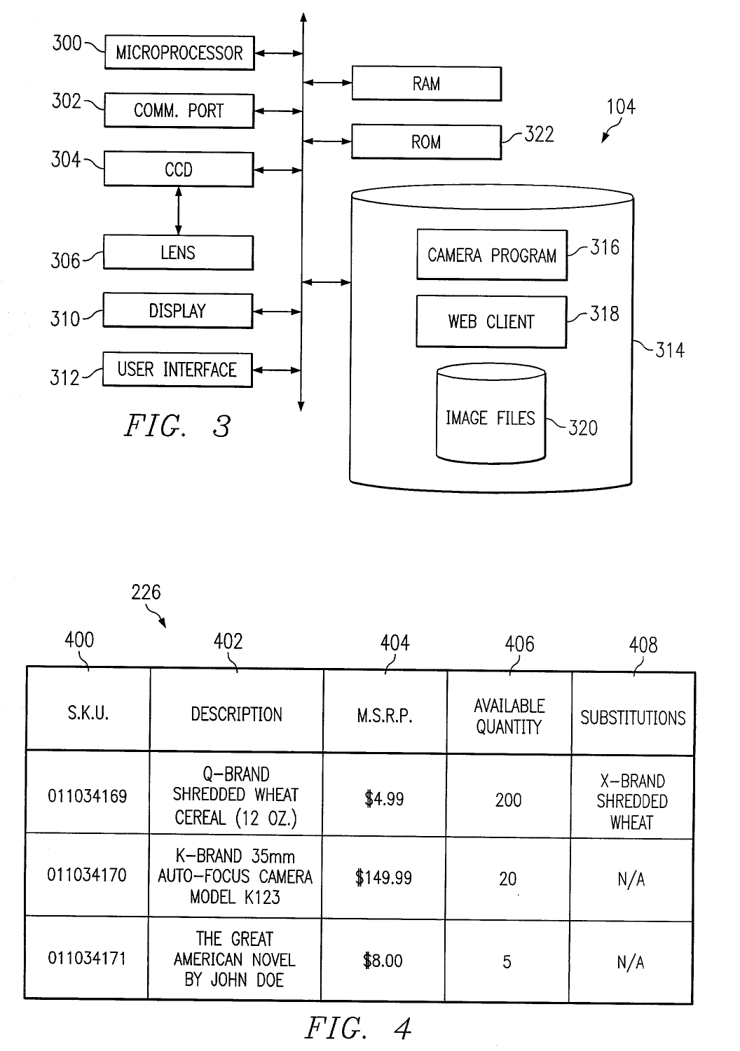

FIG. 3 illustrates several components of client device 104 according to one embodiment of the invention. The components may comprise any of the specific examples set forth above with respect to identically-named components of central server 102. Of course, specific functions performed by the components may differ from the functions performed by the identically-named components. For example, microprocessor 300 may be used to execute processor-executable process steps to obtain item information and communication port 302 may be used to transmit images of item identifiers and to receive item information based thereon.

Charge-coupled device (CCD) 304 is used to receive light impulses from lens 306 and to translate the impulses to an image signal. Accordingly, CCD 304 and lens 306 may be used to capture an image of an item identifier according to the present invention. Display 310 is used to present preview images to a user and to display information used to operate client device 104 such as remaining storage capacity, battery level, etc. Display 310 can also be used to display confirmatory messages from central server 102 to confirm that a purchase has been made. User interface 312 allows a user to input data and commands to client device 104, including commands to capture an image of an item identifier and to transmit the image to central server 102.

Data storage device 314 stores camera program 316 of processor-executable process steps. The process steps of camera program 316 may be executed by microprocessor 300 so as to control client device 104 to capture an image of an item identifier, to transmit the image, and, in response to the transmission, to receive item information associated with an item identified by the item identifier. Of course, camera program 316 may include process steps executable to provide other functions necessary for operation of client device 104.

Also stored in data storage device 314 are processor-executable steps of Web client 318. The process steps of Web client 318 may be executed by microprocessor 300 to allow client device 104 to send and receive over the Web. More specifically, Web client 318 allows client device 104 to transmit information to and to receive information from a device executing process steps of a Web server, such as central server 102.

Image files 320 are also stored in data storage device 314 and include those images captured by CCD 304 and lens 306. Image files 320 may include other image files as well.

In one embodiment, ROM 322 stores an identification number that is unique to client device 104. When a customer uses client device 104 to purchase a product, the identification number is supplied to central server 102 so as to identify the customer by identifying the client device 102 operated by the customer.

A tabular representation of a portion of item information database 226 is shown in FIG. 4. The information stored in item information database 226 may be entered by an employee through input device 210 of central server 102, or maybe received from a remote device over communication port 208. As described above, the information stored in item information database 226 may be used to determine item information based on a received image of an item identifier.

As shown, item information database 226 includes several records and associated fields. The fields include SKU field 400, description field 402, M.S.R.P. field 404, and warranty field 406. For a particular record, SKU field 400 specifies a SKU of a particular item. Similarly, description field 402 and M.S.R.P. field 404 include a description and a manufacturer's suggested retail price, respectively. Available quantity field 406 specifies how many of that item are available for purchase. Substitutions field 408 specifies what product(s), if any, can be substituted for a desired product, should the desired product be unavailable. In this way, a substitution can be made on-the-fly if the desired product is unavailable. If the substitution turns out not to be acceptable (e.g., the customer does not want a substituted soft drink), the customer may refuse to accept the goods at delivery time.

As such, the information stored in fields 400 to 408 is considered item information according to the present invention. Of course, item information database 226 may include many more records and each record may include fields other than those shown in FIG. 4.

One particular usage of item information database 226 proceeds as follows. An image of an item identifier is received by central server 102 and the item identifier is decoded to produce data shown in one of the fields of item information database 226. The item identifier may be decoded by central server 102 or by another device to which central server 102 transmits the item identifier, such as information provider 110. The decoded data is used to identify associated item information in item information database 226 and the item information is used to process an order according to the invention.

FIG. 5 shows a tabular representation of a portion of information provider database 228 according to embodiments of the invention. The data stored in information provider database 228 may be used to determine an information provider to whom an item identifier should be sent for decoding and/or determination of associated item information.

Each record in the illustrated portion of information provider database 228 includes identifier type field 500 and information provider field 502. As shown, identifier type field 500 specifies a particular type of item identifier and information provider field 500 provides a pointer to an information provider associated with the type of item identifier. Accordingly, the associated information provider may be capable of determining item information based on an item identifier of the particular type.

In a case that central server 102 cannot determine item information based on a received image of an item identifier of a particular type, central server 102 uses information provider database 228 to locate a pointer to an information provider associated with the particular type of item identifier. Using the pointer, central server 102 transmits the image of the item identifier to the information provider. In response, central server 102 receives associated item information from the information provider or information (e.g., within an enterprise). Alternatively, the information provider transmits the item information to another entity such as a client device from which the image of the item identifier was received.

As will be understood by those skilled in the art, the illustrations and accompanying descriptions of item information database 226 and information provider database 228 merely represent relationships between stored information. A number of other arrangements may be employed besides those suggested by the illustrations. Similarly, the illustrated fields and field values represent sample information only; those skilled in the art will understand that the amount and content of this information may be different from that illustrated.

FIG. 6 is a tabular diagram depicting user database 230 in accordance with a preferred embodiment of the present invention. Entries 600 represent customers using the shopping terminal system. Each of entries 600 contains the customer's name 602, shipping address 604, credit card billing address 606, credit card number 608, and credit card expiration date 610.

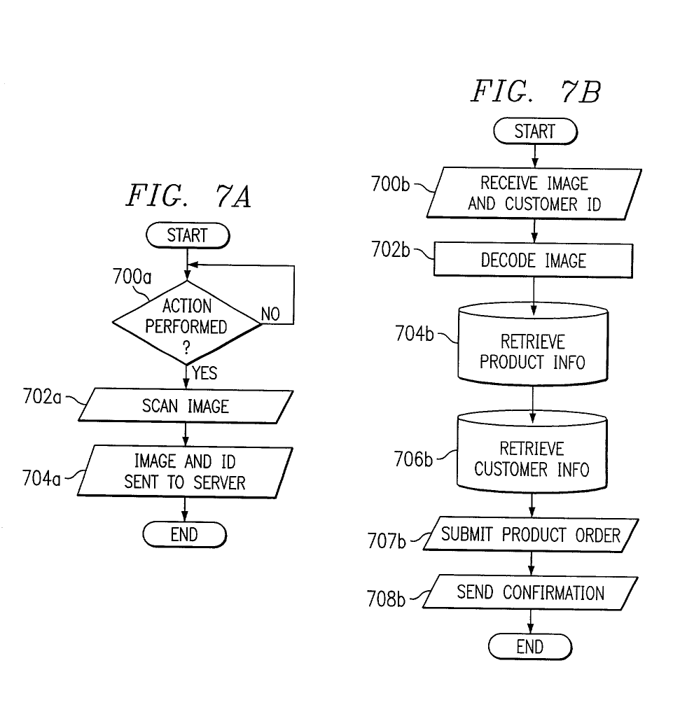

FIG. 7A is a flowchart representation of a process of submitting a single-action order in accordance with a preferred embodiment of the present invention. First, the client device waits until the single action (e.g., pressing a button on the client device) is performed (step 700A). Next, an image is scanned (step 702A). Then, the image and the client device's identifier number are transmitted to the central server (step 704A).

FIG. 7B is a flowchart representation of a process of processing a single-action order in accordance with a preferred embodiment of the present invention. First, an image and a client device identifier are received from a client device (step 700B). Then, the image is decoded to reveal the product identity (step 702B). Ordering information about the product, including price and availability, are retrieved (step 704B). Then information about the customer, including shipping and billing addresses and credit card numbers, is retrieved (step 706B). At this point, if a substitution is to be made because of lack of inventory, the item information for the substitute product is retrieved. The product order is submitted for processing, by transmitting the order information to another server, or by display or hardcopy to order-processing personnel (step 707B). Finally, a confirmation of the transaction is transmitted to the client device for display to the customer (step 708B).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of generating a product order, comprising:
receiving a data transmission from a client device, wherein the data transmission includes an image and a customer identifier;
responsive to receiving the data transmission, retrieving item information corresponding to the image;
responsive to receiving the data transmission, retrieving customer information corresponding to the customer identifier; and
combining the item information and the customer information to generate a product order.

2. The method of claim 1, wherein the image is one of a barcode, text, and a depiction of the item.

3. The method of claim 1, wherein the item information corresponds to a substitute item, wherein the substitute item is a substitute for the item.

4. The method of claim 1, wherein the customer information includes at least one of a customer name, a shipping address, a billing address, a credit card number, and a credit card expiration date.

5. The method of claim 1, wherein the step of retrieving item information includes:
submitting the image to an information provider; and
receiving the item information from the information provider.

6. The method of claim 1, wherein the data transmission is received from one of a digital camera, a mobile telephone, and a personal digital assistant.

7. The method of claim 1, further comprising:
transmitting a confirmation to the client device.

8. A method of initiating a commercial transaction, comprising:
responsive to a single action by a user, acquiring an image;
responsive to the single action, transmitting the image and a customer identifier to a server.

9. The method of claim 8, wherein the single action includes actuating a control.

10. The method of claim 9, wherein the control is a switch.

11. The method of claim 8, wherein the image is a barcode.

12. A computer program product in a computer readable medium for generating a product order, comprising instructions for:
receiving a data transmission from a client device, wherein the data transmission includes an image and a customer identifier;
responsive to receiving the data transmission, retrieving item information corresponding to the image;
responsive to receiving the data transmission, retrieving customer information corresponding to the customer identifier; and
combining the item information and the customer information to generate a product order.

13. The computer program product of claim 12, wherein the image is one of a barcode, text, and a depiction of the item.

14. The computer program product of claim 12, wherein the item information corresponds to a substitute item, wherein the substitute item is a substitute for the item.

15. The computer program product of claim 12, wherein the customer information includes at least one of a customer name, a shipping address, a billing address, a credit card number, and a credit card expiration date.

16. The computer program product of claim 12, wherein the instructions for retrieving item information include instructions for:
submitting the image to an information provider; and
receiving the item information from the information provider.

17. The computer program product of claim 12, wherein the data transmission is received from one of a digital camera, a mobile telephone, and a personal digital assistant.

18. The computer program product of claim 12, comprising additional instructions for:
transmitting a confirmation to the client device.

19. A computer program product in a computer readable medium for initiating a commercial transaction, comprising instructions for:
responsive to a single action by a user, acquiring an image;
responsive to the single action, transmitting the image and a customer identifier to a server.

20. The computer program product of claim 19, wherein the single action includes actuating a control.

21. The computer program product of claim 20, wherein the control is a switch.

22. The computer program product of claim 19, wherein the image is a barcode.

23. A data processing system for generating a product order, comprising:
a bus system;
a processing unit in communication with the bus system, wherein the processing unit includes at least one processor;
memory; and
a set of instructions located within the memory,
wherein the processing unit executes the set of instructions to perform the acts of:
receiving a data transmission from a client device, wherein the data transmission includes an image and a customer identifier;
responsive to receiving the data transmission, retrieving item information corresponding to the image;
responsive to receiving the data transmission, retrieving customer information corresponding to the customer identifier; and
combining the item information and the customer information to generate a product order.

24. The data processing system of claim 23, wherein the image is one of a barcode, text, and a depiction of the item.

25. The data processing system of claim 23, wherein the item information corresponds to a substitute item, wherein the substitute item is a substitute for the item.

26. The data processing system of claim 23, wherein the customer information includes at least one of a customer name, a shipping address, a billing address, a credit card number, and a credit card expiration date.

27. The data processing system of claim 23, wherein the processing unit executes the set of instructions to perform the additional acts of:
submitting the image to an information provider; and
receiving the item information from the information provider.

28. The data processing system of claim 23, wherein the data transmission is received from one of a digital camera, a mobile telephone, and a personal digital assistant.

29. The data processing system of claim 23, wherein the processing unit executes the set of instructions to perform the additional act of:
transmitting a confirmation to the client device.

30. A data processing system for generating a product order, comprising:
a bus system;
a processing unit in communication with the bus system, wherein the processing unit includes at least one processor;
memory; and
a set of instructions located within the memory,
wherein the processing unit executes the set of instructions to perform the acts of:
responsive to a single action by a user, acquiring an image;
responsive to the single action, transmitting the image and a customer identifier to a server.

31. The data processing system of claim 30, further comprising:
an image capturing component,
wherein the image is acquired with the image capturing component.

32. The data processing system of claim 31, wherein the image capturing component includes at least one of a charge coupled device (CCD) and a lens.

33. The data processing system of claim 30, further comprising:
a control,
wherein the single action is actuating the control.

34. The data processing system of claim 33, wherein the control includes a switch.

35. The data processing system of claim 30, further comprising:
a communications port, wherein the act of transmitting is performed by the communications port.

36. The data processing sys tem of claim 35, wherein the communications unit transmits via at least one of a local area network, a wide area network, a telephone network, a cellular network, a fiber-optic network, a satellite network, an infrared network, a radio frequency network, and the Internet.
